(19) United States
(12) Patent Application Publication
(10) Pub. No.: US 2014/0178848 A1
(43) Pub. Date: Jun. 26, 2014

(54) METHOD AND APPARATUS FOR ADMINISTERING LEARNING CONTENTS

(71) Applicant: TERACLE, INC., Seoul (KR)

(72) Inventors: In Je CHO, Seoul (KR); Ju Sun AHN, Busan (KR)

(73) Assignee: TERACLE, INC., Seoul (KR)

(21) Appl. No.: 14/104,965

(22) Filed: Dec. 12, 2013

(30) Foreign Application Priority Data
Dec. 24, 2012 (KR) 10-2012-0152070
Nov. 18, 2013 (KR) 10-2013-0140085

(51) Int. Cl. G09B 7/06

(52) U.S. Cl. CPC G09B 7/06
USPC 434/350

(57) ABSTRACT

Provided is a method and apparatus for generating learning contents. The method includes: receiving a setting on an examination paper condition from a first user terminal and providing a list of questions matching the examination paper condition to the first user terminal; receiving a selection of questions from the list of questions from the first user terminal and generating an examination paper based on the selected questions; receiving a selection of examination paper from a list of examination papers from a second user terminal and providing the selected examination paper to the second user terminal; and requesting the first and second user terminals to rate the selected questions in the generated examination paper, and receiving ratings from the first and second user terminals.

### RELATED APPLICATIONS

This application claims the benefit of Korean Patent Applications No. 10-2012-0152070, filed on Dec. 24, 2012, and No. 10-2013-0140085, filed on Nov. 18, 2013, in the Korean Intellectual Property Office, the disclosure of which is incorporated herein in its entirety by reference.

### BACKGROUND

1. Field

One or more embodiments of the present invention relate to a method and apparatus for administering learning contents, and more particularly, to a method and apparatus for generating learning contents, wherein questions are generated and registered in a server for generating learning contents by using a terminal, such as a computer, or a mobile terminal, such as a smart phone, and an examination paper is generated by using the registered questions.

2. Description of the Related Art

According to recent developments in the Internet and personal communication technologies, learning methods using electronic tools, such as remote learning and video learning, are widely used in learning fields. According to such learning methods, learning is performed only at a fixed location using a personal computer (PC) by watching an online lecture or solving an examination paper online. However, according to recent rapid vitalization of usage devices using wireless Internet, learning can be performed online while walking or moving by using a smart phone or tablet PC.

However, a question generator who generates questions online has to prepare questions by mainly using a PC, an examination paper generator who generates an examination paper has to prepare questions for the examination paper by mainly using a PC, and learners who are provided with the examination paper has to solve the examination paper when the examination paper generator prints out and hands out the generated examination paper.

Also, since it is difficult to find points of contact between a plurality of question generators and a plurality of examination paper generators, people who are talented and interested in question generation are difficult to find motivation to generate questions and examination paper generators are difficult to find questions of good quality. Even when the examination paper generators find questions, it is difficult to buy questions and generate an examination paper for free or at low costs.

### SUMMARY

One or more embodiments of the present invention include a method and apparatus for generating learning contents, wherein questions are generated by using a personal computer (PC) or a mobile terminal, such as a smart phone, and registered in a server for generating learning contents, so that questions are generated freely from time and place.

One or more embodiments of the present invention include a method and apparatus for generating learning contents, wherein questions registered in a server for generating learning contents are rated by a learner or an examination paper generator so that different prices are assigned to the registered questions.

One or more embodiments of the present invention include a method and apparatus for generating learning contents, wherein questions registered in a server for generating learning contents are received by using a personal PC or a mobile terminal and an examination paper is generated by using the received questions, so that the examination paper suitable for learning purposes is generated freely from time and place.

One or more embodiments of the present invention include a method and apparatus for generating learning contents, wherein an examination paper registered in a server for generating learning contents is received and solved by using a PC or a mobile terminal, so that questions of good quality in the examination paper are systematically solved freely from time and place and learning is repeatedly performed to increase study achievement of a learner.

One or more embodiments of the present invention include a method and apparatus for generating learning contents, wherein a passage for generating questions of good quality is made for frame or financial gains of a question generator, and an examination paper generator easily and conveniently generates an examination paper and uses questions under desired conditions at low costs.

Additional aspects will be set forth in part in the description which follows and, in part, will be apparent from the description, or may be learned by practice of the presented embodiments.

According to one or more embodiments of the present invention, a method of administering learning contents by a server, the method includes: receiving a setting on an examination paper condition from a first user terminal and providing a list of questions matching the examination paper condition to the first user terminal; receiving a selection of questions from the list of questions from the first user terminal and generating an examination paper based on the selected questions; providing to the second user terminal a list of examination papers; receiving a selection of the examination paper from a list of examination papers from a second user terminal and providing the selected examination paper to the second user terminal; and requesting the first and second user terminals to rate the selected questions in the generated examination paper, and receiving the ratings from the first and second user terminals.

The examination paper condition may include at least one condition chosen from a subject and unit of an examination paper, a difficulty level of questions, or learner information.

The method may further include, when a difference between the ratings of the first and second user terminals is equal to or higher than a set range, requesting the first and second user terminals to re-rate the selected questions.

The method may further include determining ranks of questions based on the ratings of the first and second user terminals.

The ranks may be determined based on final results calculated by applying weights to each of the ratings of the first and second user terminals.

The method may further include providing points assigned to questions to a third user terminal that registered the questions, based on the ranks.

The method may further include receiving a performance result of the selected examination paper from the second user terminal, and providing a grade of the performance result to the second user terminal.

The method may further include receiving questions and question information from a third user terminal.

The question information may include at least one of a subject and unit of a question, a difficulty level of a question, question generator information, and learner information.

The method may further include providing grade information of question generators determined based on points assigned to questions and numbers of times the questions are selected according to the ratings to the first through third user terminals.

According to one or more embodiments of the present invention, an apparatus for generating learning contents, the apparatus includes: a question extracting module for receiving a setting on an examination paper condition from a first user terminal and providing a list of questions matching the examination paper condition to the first user terminal; an examination paper generating module for receiving a selection of questions from the list of questions from the first user terminal and generating an examination paper based on the selected questions; an examination paper extracting module for receiving a selection of examination paper from a list of examination papers from a second user terminal and providing a selected examination paper to the second user terminal; and a question evaluating module for requesting the first and second user terminals to rate the selected questions in the generated examination paper, and receiving ratings from the first and second user terminals.

The examination paper condition may include at least one condition chosen from a subject and unit of an examination paper, a difficulty level of questions, or learner information.

When a difference between the ratings of the first and second user terminals is equal to or higher than a set range, the question evaluating module may request the first and second user terminals to re-rate the selected questions.

The question evaluating module may determine ranks of questions based on the ratings of the first and second user terminals.

The question evaluating module may provide points assigned to questions to a third user terminal that registered questions, based on the ranks.

The apparatus may further include a learning evaluating module for receiving a performance result of the selected examination paper from the second user terminal, and providing a grade of the performance result to the second user terminal.

The apparatus may further include a question registering module for storing questions and question information received from a third user terminal.

The question information may include at least one of a subject and unit of a question, a difficulty level of a question, question generator information, and learner information.

The question evaluating module may provide grade information of question generators determined based on points assigned to questions and numbers of times the questions are selected according to the ratings to the first through third user terminals.

According to one or more embodiments of the present invention, a computer-readable recording medium has recorded thereon a program for executing the method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram of a system for generating learning contents, according to an embodiment of the present invention;

FIG. 2 is a block diagram of a question generating terminal according to an embodiment of the present invention;

FIG. 3 is a flowchart illustrating a method of generating questions by using a learning contents generating application in a question generating terminal, according to an embodiment of the present invention;

FIG. 4 is a block diagram of an examination paper generating terminal according to an embodiment of the present invention;

FIG. 5 is a flowchart illustrating a method of generating an examination paper by using learning contents generating application in an examination paper generating terminal, according to an embodiment of the present invention;

FIG. 6 is a block diagram of a learner terminal for solving an examination paper, according to an embodiment of the present invention;

FIG. 7 is a flowchart illustrating a method of solving an examination paper by using a learning contents generating application in a learner terminal, according to an embodiment of the present invention;

FIG. 8 is a block diagram of a server for generating learning contents, according to an embodiment of the present invention; and

FIG. 9 is a flowchart illustrating a method of providing learning contents, according to an embodiment of the present invention.

### DETAILED DESCRIPTION

Hereinafter, the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

While such terms as “first,” “second,” etc., may be used to describe various components, such components must not be limited to the above terms. Also, a singular expression may also include a plural expression unless clearly defined otherwise.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

As used herein, the term “and/or” includes any and all combinations of one or more of the associated listed items. Expressions such as “at least one of,” when preceding a list of elements, modify the entire list of elements and do not modify the individual elements of the list.

Herein, “communication”, a “communication network”, an “Internet network”, and a “network” may be used in the same meaning. Such terms denote wired and wireless local area and wide area data transmitting and receiving networks capable of transmitting and receiving files between a user terminal, another user terminal, and a download server.

Herein, a question generating terminal is operated by one or more persons who generate questions, i.e., a question generator; an examination paper generating terminal is operated by one or more persons who select questions to generate examination papers, i.e., an examination paper genitor; and a learner terminal is operated by one or more persons who utilize the learning contents, i.e., a learner.

One or more embodiments of the present invention will be described below in more detail with reference to the accompanying drawings. Those components that are the same or are in correspondence are rendered the same reference numeral regardless of the figure number, and redundant explanations are omitted.

Herein, questions generated by using a question generating terminal are evaluated through at least one of an examination paper generating terminal and a learner terminal.

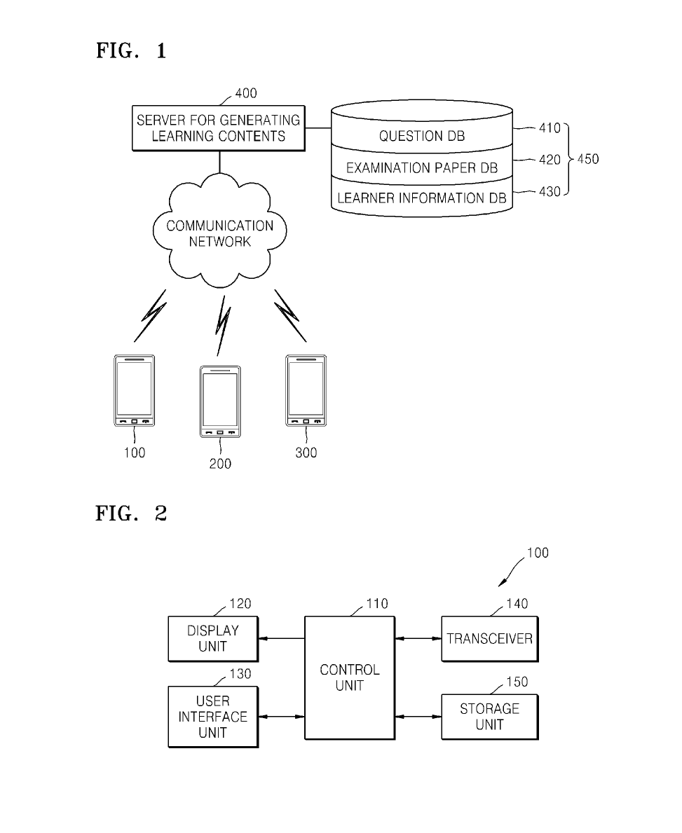

FIG. 1 is a diagram of a system for generating learning contents, according to an embodiment of the present invention.

Referring to FIG. 1, the system includes a question generating terminal 100, an examination paper generating terminal 200, a learner terminal 300 for solving an examination paper, and a server 400 for generating (and administering) learning contents.

User terminals, such as the question generating terminal 100, the examination paper generating terminal 200, and the learner terminal 300, are apparatuses connectable to the server 400 through a communication network, such as the Internet, and may be a desk top computer, a mobile terminal, such as a laptop, a handheld apparatus, a smart phone, or a tap, or an arbitrary apparatus using one of them or directly/indirectly connected thereto.

The question generating terminal 100 connects to the server 400 to download and install a learning contents generating application for generating questions.

Then, the question generating terminal 100 executes the learning contents generating application regardless of time and place to generate questions, and register the generated questions in the server 400.

The examination paper generating terminal 200 connects to the server 400 to download and install the learning contents generating application for generating an examination paper.

Then, the examination paper generating terminal 200 executes the learning contents generating application regardless of time and place to receive conditions of an examination paper to be generated. Here, the conditions may be a subject of the examination paper, questions of a certain question generator, and a difficulty level of the examination paper.

The examination paper generating terminal 200 transmits the conditions to the server 400, and receives and displays questions corresponding to the conditions from the server 400.

Also, the examination paper generating terminal 200 receives selection on questions to be included in the examination paper from among the displayed questions, transmits the selected questions to the server 400, and requests the server 400 to generate the examination paper.

Then, the examination paper generating terminal 200 receives an evaluation on questions registered in the server 400, and transmits ratings of the questions to the server 400.

The learner terminal 300 for solving the examination paper connects to the server 400 to download and install the learning contents generating application for solving an examination paper.

Then, the learner terminal 300 executes the learning contents generating application regardless of time and place to receive the examination paper registered in the server 400, and when the received examination paper is performed, transmits a performance result of the examination paper to the server 400.

Then, the learner terminal 300 receives ratings on questions registered in the examination paper, and transmits ratings of the questions to the server 400.

The server 400 is connected to the question generating terminal 100, the examination paper generating terminal 200, and the learner terminal 300 through the communication network, and is connected to a database (DB) 450.

The DB 450 may include a question DB 410 for storing questions received from the question generating terminal 100, an examination paper DB 420 for storing examination papers received from the examination paper generating terminal 200, and a learner information DB 430 of a learner who solves an examination paper.

The question DB 410 not only stores questions but also question information, wherein the question information includes at least one of a subject and unit of a question, a difficulty level of a question, question generator information, and learner information about a certain learner who is to solve questions. The learner information may include a region, a school, or a class where a learner is from, and a certain level or grade capable of solving a question. In the question DB 410, a correct answer and at least one solution may be matched to and stored with each question. A solution may be understood as a process to reach an answer. For example, a mathematical problem may only have one correct answer but more than one solution to arrive at the correct answer. A plurality of solutions for one question may be registered by a question generator of the question or another question generator. A solution may be presented in various forms, such as texts, images, moving images, audio, and presentation. Also, a rating of each question may be stored in the question DB 410.

The examination paper DB 420 not only stores an examination paper but also examination paper condition information. The examination paper condition information is about conditions input by an examination paper generator while generating an examination paper, and includes at least one of a subject and unit of an examination paper, a difficulty level of questions in an examination paper, learner information about a certain learner who is to solve a question (for example, a school, a class, a level, or a grade), and examination paper generator information. The examination paper DB 420 may store ratings on questions rated by an examination paper generator.

The learner information DB 430 stores information about a school and a class of a learner who registered for a membership, information about a result of solving an examination paper by a learner, and ratings on questions rated by a learner.

The learner information DB 430 further stores information about a level and a grade provided according to information about a result of solving an examination paper by a learner in the learning contents generating application.

The server 400 transmits the learning contents generating application to the question generating terminal 100, the examination paper generating terminal 200, and the learner terminal 300.

The server 400 receives and registers questions and question information from the question generating terminal 100.

Then, upon receiving the conditions of the examination paper to be generated from the examination paper generating terminal 200, the server 400 extracts questions corresponding to the conditions and transmits a list of questions to the examination paper generating terminal 200.

Then, upon receiving selection on questions to be included in the examination paper from the examination paper generating terminal 200, the server 400 generates the examination paper by using the selected questions.

Then, the server 400 matches and stores the generated examination paper and the conditions.

Then, the server 400 receives ratings on questions in the list or ratings on questions in the generated examination paper from the examination paper generating terminal 200, and stores the received ratings.

Also, when the learner terminal 300 is connected, the server 400 transmits a list of subjects suitable for learner information to the learner terminal 300.

Here, a list of subjects may be pre-registered by a learner, or set based on learner information.

The learner information may be about a certain school or class, or a certain grade or level provided by a learning contents generating application.

Also, upon receiving a selection on a certain subject from the learner terminal 300, the server 400 transmits a list of examination papers registered in the certain subject, and transmits an examination paper selected from the list of examination papers by the examination paper generating terminal 200 or the learner terminal 300 to the learner terminal 300.

Also, the server 400 receives and stores results of solving an examination paper from the learner terminal 300.

Then, the server 400 receives ratings on questions in the examination paper from the learner terminal 300, and stores the received ratings.

The server 400 may determine ranks of questions by using the ratings received from the examination paper generating terminal 200 and the ratings received from the learner terminal 300, and provide points or prizes to question generator according to the ranks.

Here, when the ratings received from the examination paper generating terminal 200 and the ratings received from the learner terminal 300 are different, the server 400 may request the examination paper generating terminal 200 and the learner terminal 300 to re-rate a corresponding question.

FIG. 2 is a block diagram of the question generating terminal 100 according to an embodiment of the present invention.

Referring to FIG. 2, the question generating terminal 100 includes a control unit 110, a display unit 120, a user interface unit 130, a transceiver 140, and a storage unit 150.

The control unit 110 controls overall operations of the question generating terminal 100, and when the learning contents generating application is executed, transmits login information to the server 400.

Then, when the server 400 approves a login, the control unit 110 receives questions and question information from question generator, transmits the questions and question information to the server 400, and requests the server 400 to register the questions. The question information includes at least one of a subject and unit of a question, a difficulty level of a question, question generator information, and learner information about a certain learner who is to solve a problem. The control unit 110 may receive a correct answer and a solution of a question from a question generator, and request the server 400 to register the correct answer and the solution. The control unit 110 may receive the question and the question information directly from question generator through a question input window displayed on a screen, or may be uploaded with the question and the question information prepared in any one of various forms, such as texts, images, moving images, audio, and presentation. The control unit 110 may receive a solution of a question pre-generated by another question generator from the question generator, transmit the received solution to the server 400, and request the server 400 to register the solution.

The display unit 120 displays a screen for executing the learning contents generating application. In detail, the display unit 120 receives the question and the question information from the question generator. The display unit 120 may display whether a generated question is registered and a question evaluation result. The display unit 120 may include at least one of a liquid crystal display (LCD), an organic light-emitting display (OLED), an electrophoretic display (EPD), a flexible display, and a 3-dimensional (3D) display. Here, two or more display units 120 may exist according to a structure of the question generating terminal 100.

The user interface unit 130 provides an interface with a user to control operations of the question generating terminal 100. In detail, the user interface unit 130 provides an input window for receiving a manipulation signal of the question generator for generating questions by using the learning contents generating application, and transmits a question and question information to the control unit 110.

The transceiver 140 transmits and receives data, in detail, transmits and receives data related to execution of the learning contents generating application to and from the server 400.

Then, the transceiver 140 transmits a question and question information to the server 400. The transceiver 140 receives an evaluation result on the question from the server 400.

The storage unit 150 may include a storage medium of at least one of a flash memory type, a hard disk type, a multimedia card micro type, a card type memory (for example, a secure digital (SD) card or an extreme digital (XD) card), a random access memory (RAM), and a read only memory (ROM). The storage unit 150 stores the learning contents generating application and the questions. Also, the storage unit 150 may store points obtained according to ratings of the questions.

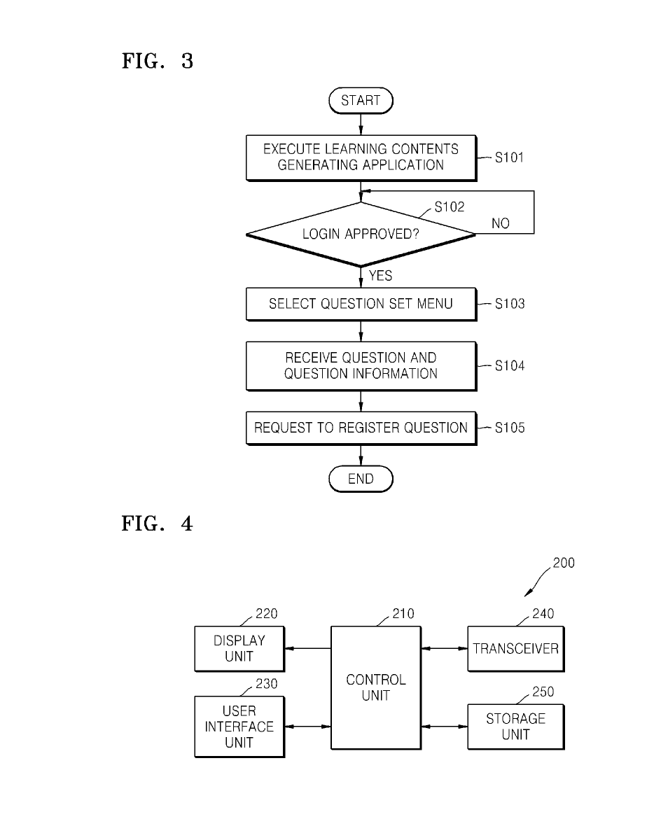

FIG. 3 is a flowchart illustrating a method of generating questions by using the learning contents generating application in the question generating terminal 100, according to an embodiment of the present invention.

Referring to FIG. 3, when the learning contents generating application is executed in operation S101, the question generating terminal 100 requests the server 400 for a login by using login information received from the question generator. The question generator is not limited as long as he/she is capable of providing questions, for example, a teacher or instructor of a school or private institute, a student, or an ordinary person.

Here, the login information may be an identification (ID) and a password input to the server 400 by the question generator during a membership registration.

Then, when the server 400 approves the login, the question generating terminal 100 displays a menu of the learning contents generating application, in operation S102.

Then, when the question generator selects a question set menu from the displayed menu, in operation S103, the question generating terminal 100 displays an input window for inputting a question and question information.

The question generating terminal 100 receives the question and the question information from the question generator, in operation S104. The question generator may input a correct answer and a solution to the question. The question, the correct answer, and the solution may be directly input to an input window provided in the screen of the question generating terminal 100, or may be prepared as a file of any one of various forms, such as texts, images, moving images, audio, animation, and presentation, and updated to the question generating terminal 100.

Then, upon receiving a request to register the question received from the question generator, the question generating terminal 100 transmits the question and the question information to the server 400 and requests the server 400 to register the question, in operation S105.

FIG. 4 is a block diagram of the examination paper generating terminal 200 according to an embodiment of the present invention.

Referring to FIG. 4, the examination paper generating terminal 200 includes a control unit 210, a display unit 220, a user interface unit 230, a transceiver 240, and a storage unit 250.

The control unit 210 controls overall operations of the examination paper generating terminal 200, and when the learning contents generating application is executed, transmits login information to the server 400.

Then, when the login is approved by the server 400, the control unit 210 receives and transmits the examination paper condition from the examination paper generator to the server 400.

Then, the control unit 210 receives and displays the list of questions suitable to the examination paper conditions from the server 400, and receives selection on questions to be included in the examination paper from among the list from the examination paper generator.

Next, the control unit 210 receives information about the examination paper to be generated from the examination paper generator, transmits the questions to be included in the examination paper to the server 400, and requests the server 400 to generate the examination paper.

Then, the control unit 210 receives ratings on questions in the list or ratings on questions in the examination paper from the examination paper generator, and transmits the received ratings to the server 400.

The display unit 220 displays a screen for executing the learning contents generating application. The display unit 220 may receive and display the examination paper conditions and the ratings from the examination paper generator, and may display the list of questions received from the server 400. The display unit 220 may include at least one of an LCD, an OLED, an EPD, a flexible display, and a 3D display. Two or more display units 220 may exist according to a structure of the examination paper generating terminal 200.

The user interface unit 230 provides an interface with the user for controlling operations of the examination paper generating terminal 200. In detail, the user interface unit 230 may receive a manipulation signal of the examination paper generator for generating the examination paper by using the learning contents generating application, and transmit the manipulation signal to the control unit 210.

The transceiver 240 transmits and receives data, in detail, transmits and receives data related to execution of the learning contents generating application to and from the server 400.

Also, the transceiver 240 transmits questions to be included in the examination paper and examination paper information to the server 400.

The storage unit 250 stores the learning contents generating application and the generated examination paper. The storage unit 250 may include a storage medium of at least one of a flash memory type, a hard disk type, a multimedia card micro type, a card type memory (for example, an SD memory or an XD memory), a RAM, and a ROM.

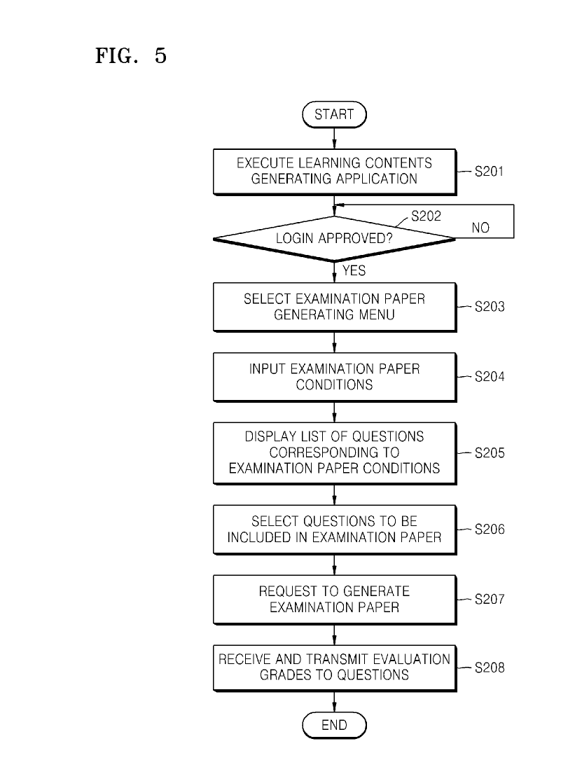

FIG. 5 is a flowchart illustrating a method of generating an examination paper by using the learning contents generating application in the examination paper generating terminal 200, according to an embodiment of the present invention.

Referring to FIG. 5, when the learning contents generating application is executed, the examination paper generating terminal 200 transmits login information received from the examination paper generator to the server 400 to request the server 400 for login, in operation S201. The examination paper generator may be an education related expert, such as a professor or a teacher. The examination paper generator may be managed by the server 400 to externally have reliability, objectivity, and transparency.

Here, the login information may be an ID and a password input by the examination paper generator while registering for a membership in the server 400.

Then, when the server 400 approves the login, the examination paper generating terminal 200 displays a menu of the learning contents generating application, in operation S202.

Then, upon receiving a selection on an examination paper generating menu in operation S203, the examination paper generating terminal 200 provides an input window for inputting examination paper conditions.

The examination paper generating terminal 200 receives the examination paper conditions from the examination paper generator, in operation S204.

The examination paper generating terminal 200 transmits the examination paper conditions to the server 400, and receives and displays a list of questions corresponding to the examination paper conditions from the server 400, in operation S205.

The examination paper generating terminal 200 receives selection on questions to be included in the examination paper from among the list of questions from the examination paper generator, in operation S206, transmits the list of selected questions to the server 400, and requests the server 400 to generate the examination paper in operation S207.

The examination paper generating terminal 200 receives ratings on questions in the list or ratings on questions in the examination paper from the examination paper generator, and transmits the received ratings to the server 400, in operation S208.

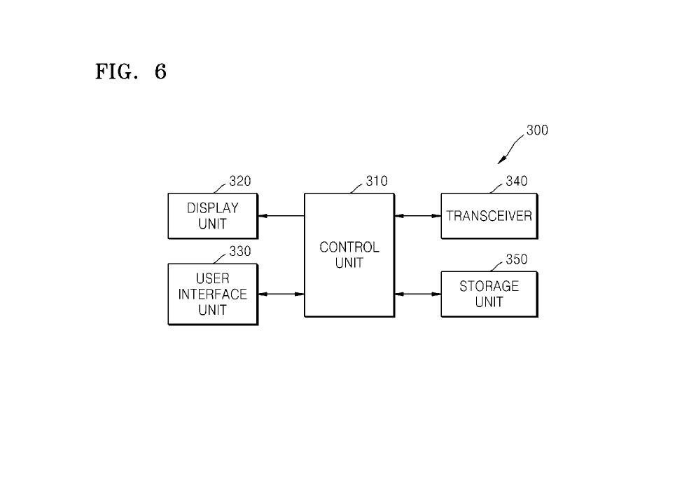

FIG. 6 is a block diagram of the learner terminal 300 for solving an examination paper, according to an embodiment of the present invention.

Referring to FIG. 6, the learner terminal 300 includes a control unit 310, a display unit 320, a user interface unit 330, a transceiver 340, and a storage unit 350.

The control unit 310 controls overall operations of the learner terminal 300, and when the learning contents generating application is executed, transmits login information to the server 400.

Also, when the server 400 approves login, the control unit 310 receives and displays a list of subjects suitable to learner information from the server 400. Here, the list of subjects may be pre-registered by a learner, or may be pre-set according to learner information, i.e., a certain school or class, or a certain grade or level provided by the learning contents generating application.

Upon receiving a selection on a subject from the list of subjects from the learner, the control unit 310 receives and displays a list of examination papers on the selected subject from the server 400.

Then, upon receiving a selection on an examination paper from the list of examination papers from the learner, the control unit 310 receives and displays the selected examination paper from the server 400.

Then, when the learner solves the examination paper, the control unit 310 transmits a performance result of the examination paper to the server 400. The control unit 310 receives a score according to the performance result and a grade of the learner based on the score and statistics of performance results of other learners, and displays the grade on the display unit 320.

Then, the control unit 310 receives ratings on questions in the examination paper from the learner, and transmits the ratings to the server 400.

The display unit 320 displays a screen for executing the learning contents generating application. The display unit 320 may display the list of subjects, the examination paper, the score, and the grade. The display unit 320 may include at least one of an LCD, an OLED, an EPD, a flexible display, and a 3D display. Also, two or more display units 320 may exist according to a structure of the learner terminal 300.

The user interface unit 330 provides an interface with a user to control operations of the learner terminal 300. In detail, the user interface unit 330 receives and transmits a manipulation signal of the learner for solving the examination paper by using the learning contents generating application to the control unit 310.

The transceiver 340 transmits and receives data, in detail, transmits and receives data related to execution of the learning contents generating application to and from the server 400.

The storage unit 350 stores the learning contents generating application. The storage unit 350 stores the performance result and the grade of the learner. The storage unit 350 may include a storage medium of at least one of a flash memory type, a hard disk type, a multimedia card micro type, a card type memory (for example, an SD or XD memory), a RAM, and a ROM.

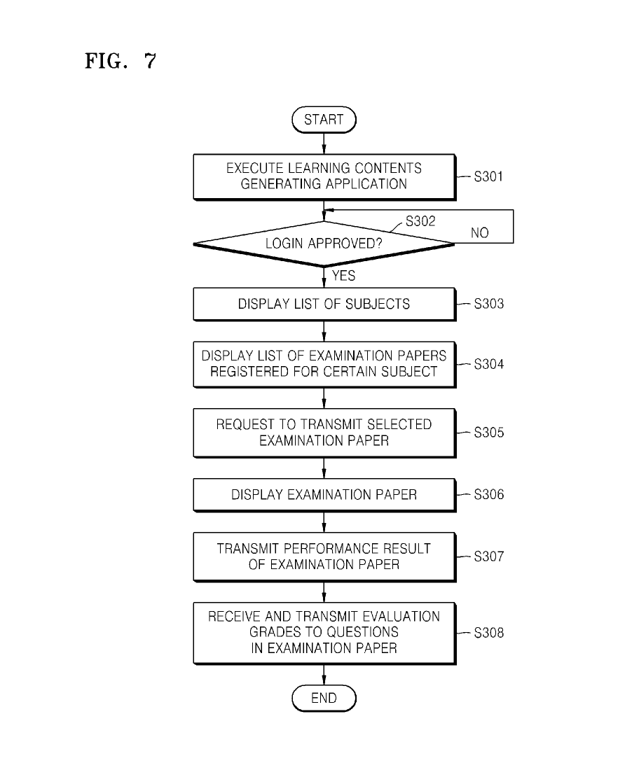

FIG. 7 is a flowchart illustrating a method of solving an examination paper by using the learning contents generating application in the learner terminal 300, according to an embodiment of the present invention.

Referring to FIG. 7, when the learning contents generating application is executed in operation S301, the learner terminal 300 transmits login information received from the learner to the server 400 and requests the server 400 for login in operation S302.

Here, the login information may be an ID and a password input by the learner to the server 400 during membership registration.

When the server 400 approves the login in operation S302, learner terminal 300 receives and displays the list of subjects of the learner from the server 400 in operation S303.

Then, the learner terminal 300 receives selection on a certain subject from the list of subjects from the learner, and receives and displays the list of examination papers on the certain subject from the server, in operation S304.

Then, upon receiving a selection on an examination paper from the list of examination papers from the learner, the learner terminal 300 requests the server 400 to transmit the selected examination paper in operation S305.

Then, the learner terminal 300 receives and displays the examination paper from the server 400 in operation S306, and when the learner solves the examination paper, transmits a performance result of the examination paper to the server 400 in operation S307.

Then, the learner terminal 300 receives ratings on questions in the examination paper from, and transmits the ratings to the server 400 in operation S308.

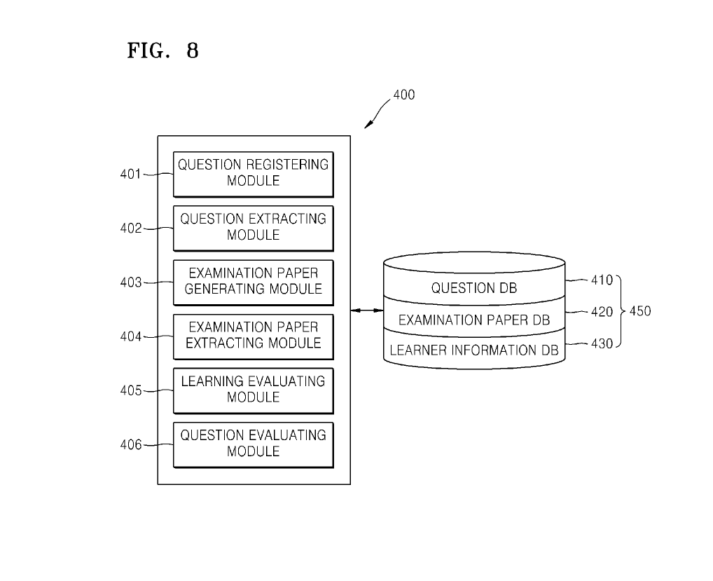

FIG. 8 is a block diagram of the server 400 for generating learning contents, according to an embodiment of the present invention.

The server 400 may include hardware in a computing device to which users connect so as to execute a program for generating learning contents, or may include software or circuits. One server 400 may operate a plurality of the programs, or one or more servers 400 may exist according to functions of the program.

At least some of components included in the server 400 may be software including at least one of an operating system, an application program module, and another program module, and may be physically stored in any well-known type of storage device.

Also, a middleware on a database in the server 400 or servers for performing a payment process may be connected to the server 400, but details thereof are not described herein.

Referring to FIG. 8, the server 400 may include a question registering module 401, a question extracting module 402, an examination paper generating module 403, an examination paper extracting module 404, a learning evaluating module 405, and a question evaluating module 406. Here, a module denotes a logical combination of general-purpose hardware and/or software.

The question registering module 401 receives questions and question information from the question generating terminal 100, classifies and stores the questions according to the question information in the question DB 410. The question registering module 401 may match a correct answer and at least one solution to each question and store the correct answer and the at least one solution in the question DB 410. A plurality of solutions for one question may be received from different question generating terminals 100.

The question extracting module 402 receives settings on examination paper conditions from the examination paper generating terminal 200, and provides a list of questions matching the examination paper conditions to the examination paper generating terminal 200.

The examination paper generating module 403 receives selection on questions from the list of questions from the examination paper generating terminal 200, extracts the selected questions from the question DB 410, and generates an examination paper. The generated examination paper is stored in the examination paper DB 420.

The examination paper extracting module 404 provides a list of examination papers on a certain subject to the learner terminal 300, receives selection on an examination paper from the list of examination papers from the learner terminal 300, extracts the selected examination paper from the examination paper DB 420, and provides the extracted examination paper to the learner terminal 300.

The learning evaluating module 405 receives a performance result on the selected examination paper from the learner terminal 300, grades answers according to the performance result, and provides a score and a grade to the learner terminal 300.

The question evaluating module 406 requests the examination paper generating terminal 200 and the learner terminal 300 to rate the questions in the examination paper, and receives the ratings. The question evaluating module 406 determines ranks of the questions by using ratings received from the examination paper generating terminal 200 and ratings received from the learner terminal 300. The question evaluating module 406 determines pre-determined points or prizes according to the ranks of questions, and provides information about the points or prizes to the question generating terminal 100 in which a corresponding question is registered.

When a difference between the ratings received from the examination paper generating terminal 200 and the learner terminal 300 is higher than a set range, the question evaluating module 406 may request the examination paper generating terminal 200 and the learner terminal 300 to re-evaluate a corresponding question.

Also, the question evaluating module 406 may calculate a final evaluation result by assigning different weights to the ratings received from the examination paper generating terminal 200 and the learner terminal 300. As described above, in the current embodiment, the evaluation on the questions generated through the question generating terminal 100 is performed by at least one of the examination paper generating terminal 200 and the learner terminal 300, so that the evaluation is considered when the question generating terminal 100 generates questions or the examination paper generating terminal 200 selects questions and generates an examination paper.

Also, the question evaluating module 406 determines a national rank, or a regional rank or grade of an question generator based on a point of a question and a number of times the question is selected according to ratings received from the examination paper generating terminal 200 and the learner terminal 300, and displays the rank and/or grade of the question generator on terminals of other question generators, examination paper generators, or learners, so that the examination paper generating terminal 200 considers the rank and/or grade while selecting a question and generating an examination paper.

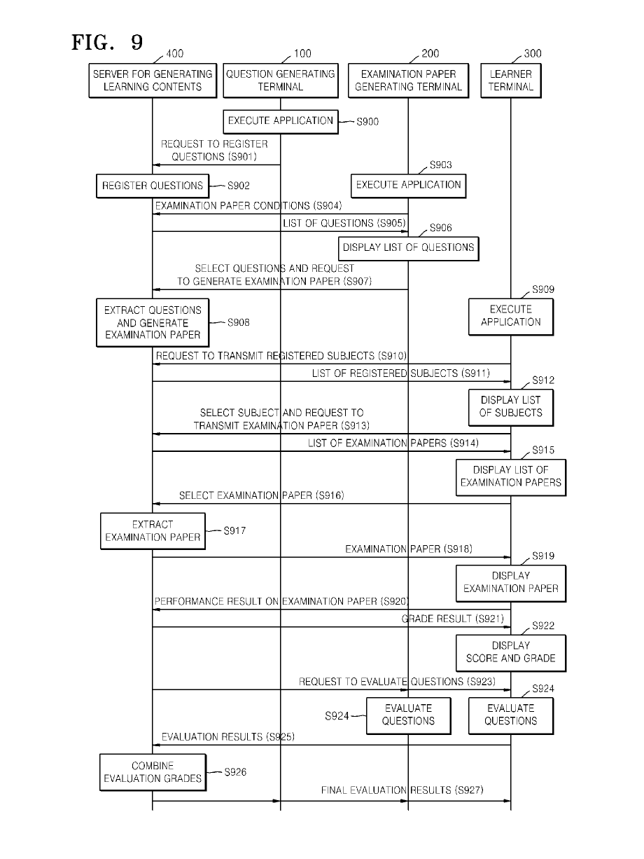

FIG. 9 is a flowchart illustrating a method of providing learning contents, according to an embodiment of the present invention.

Referring to FIG. 9, when the learning contents generating application is executed in operation S900 and the questions and the question information are received from the question generator, the question generating terminal 100 requests the server 400 to register the questions in operation S901.

The server 400 receives the request to register the questions from the question generating terminal 100, and stores the questions and the question information received from the question generating terminal 100 in the question DB 410 in operation S902. A correct answer and at least one solution may be stored together with each question. The server 400 may receive solutions on the same question from a plurality of the question generating terminals 100, and receive the solutions in the question DB 410.

When the learning contents generating application is executed in operation S903 and the setting on the examination paper conditions of the examination paper to be generated is received from the examination paper generator, the examination paper generating terminal 200 transmits the examination paper conditions to the server 400 in operation S904.

The server 400 receives the examination paper conditions from the examination paper generating terminal 200, and provides the list of questions matching the examination paper conditions to the examination paper generating terminal 200 in operation S905.

The examination paper generating terminal 200 displays the list of questions in operation S906, and when selection on questions to be included in the examination paper from the list of questions is received from the examination paper generator, transmits the selected questions to the server 400 and requests the server 400 to generate the examination paper in operation S907.

The server 400 receives the selection on the questions from the examination paper generating terminal 200, and generates the examination paper by extracting the selected questions from the question DB 410, in operation S908.

When the learning contents generating application is executed in operation S909, the learner terminal 300 requests the server 400 to transmit registered subjects of the learner in operation S910.

The server 400 transmits the list of registered subjects of the learner to the learner terminal 300 based on the learner information, in operation S911.

The learner terminal 300 receives and displays the list of subjects from the server 400, in operation S912.

Upon receiving selection on a certain subject from the learner, the learner terminal 300 requests the server 400 to transmit the examination paper on the certain subject selected by the learner, in operation S913.

The server 400 receives the request to transmit the examination paper of the certain subject from the learner terminal 300, and transmits the list of examination papers on the certain subject to the learner terminal 300, in operation S914.

The learner terminal 300 receives and displays the list of examination papers on the certain subject from the server 400, in operation S915.

The learner terminal 300 receives selection on an examination paper from the list of examination papers from the learner, and requests the server 400 to transmit the examination paper selected by the learner, in operation S916.

The server 400 receives the request from the learner terminal 300, extracts the examination paper from the examination paper DB 420 in operation S917, and transmits the extracted examination paper to the learner terminal 300 in operation S918.

The learner terminal 300 displays the examination paper received from the server 400 in operation S919, and transmits the performance result on the examination paper of the learner to the server 400 in operation S920. The learner terminal 300 may transmit the performance result individually with respect to the questions in the examination paper, or integrally with respect to the questions in the examination paper.

The server 400 grades the performance result, and transmits the grade result to the learner terminal 300 in operation S921. The grade result may include whether a question is right, a solution, a score and grade according to a percentage of correct answers.

The learner terminal 300 receives the grade result from the server 400, and may display the score and the grade in operation S922. Also, the learner terminal 300 may display whether each question is right and the solution of each question.

The server 400 may request the examination paper generating terminal 200 and the learner terminal 300 to rate the questions in the examination paper, in operation S923. The server 400 may request the examination paper generating terminal 200 to rate the questions when the examination paper generating terminal 200 requests to generate the examination paper or after the examination paper is generated.

The examination paper generating terminal 200 and the learner terminal 300 receive the evaluation on the questions respectively from the examination paper generator and the learner in operation S924, and transmit the ratings to the server 400 in operation S925.

The server 400 may determine the ranks of the questions by combining the ratings received from the examination paper generating terminal 200 and the ratings received from the learner terminal 300 in operation S926. When the difference between the ratings received from the examination paper generating terminal 200 and the ratings received from the learner terminal 300 is higher than the set range, the server 400 may request the examination paper generating terminal 200 and the learner terminal 300 to re-evaluate the questions.

The server 400 may transmit the final ratings to the question generating terminal 100, the examination paper generating terminal 200, and the learner terminal 300 in operation S927. For example, the server 400 may determine points or prizes to the questions in the examination paper, and provide the information about the points and prizes to the question generating terminal 100. Also, the server 400 may provide information about the rank or the grade of the question generator determined based on the points of the questions and the number of times the questions are selected, to the examination paper generating terminal 200 and the learner terminal 300.

When the question generating terminal 100 requests to register the questions, the server 400 may automatically rate the questions through a question evaluating algorithm while storing the questions in the question DB 410.

The question generating terminal 100, the examination paper generating terminal 200, and the learner terminal 300 may simultaneously or individually connect to the server 400 to generate questions, generate an examination paper, and perform learning.

As described above, according to the one or more of the above embodiments of the present invention, questions are generated by using a PC or a mobile terminal, such as a smart phone, and registered in a server for generating learning contents, so that questions are generated freely from time and place.

Also, questions registered in a server for generating learning contents are received by using a PC or a terminal and an examination paper is generated by using the received questions, so that the examination paper suitable for learning purposes is generated freely from time and place.

Also, an examination paper registered in a server for generating learning contents is received and solved by using a PC or a mobile terminal, so that questions of good quality in the examination paper are systematically solved freely from time and place and learning is repeatedly performed to increase study achievement of a learner.

Also, a passage for generating questions of good quality is made for frame or financial gains of a question generator, and a question generator easily and conveniently generates and uses questions under desired conditions at low costs.

The method of providing learning contents according to one or more embodiments of the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random-access memory (RAM), CD-ROMs, magnetic tapes, floppy disks, optical data storage devices, etc. The computer-readable recording medium may also be distributed over network coupled computer systems so that the computer readable code is stored and executed in a distributed fashion. Also, functional programs, codes, and code segments for accomplishing the one or more embodiments of the present invention may be easily construed by programmers skilled in the art to which the one or more embodiments of the present invention pertain.

It should be understood that the exemplary embodiments described therein should be considered in a descriptive sense only and not for purposes of limitation. Descriptions of features or aspects within each embodiment should typically be considered as available for other similar features or aspects in other embodiments. While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of administering learning contents, the method comprising executing the following steps by a server:
receiving from a first user terminal a setting on an examination paper condition;
providing to the first user terminal a list of questions matching the examination paper condition;
receiving from the first user terminal a selection of questions from the list of questions;
generating an examination paper based on the selected questions;
providing to the second user terminal a list of examination papers;
receiving from a second user terminal a selection of examination paper from the list of examination papers; providing the selected examination paper to the second user terminal; requesting the first and second user terminals to rate the selected questions in the generated examination paper; and
receiving the ratings from the first and second user terminals.

2. The method of claim 1, wherein the examination paper condition comprises at least one condition chosen from a subject and unit of an examination paper, a difficulty level of questions, or learner information.

3. The method of claim 1, further comprising, when a difference between the ratings of the first and second user terminals is equal to or higher than a set range, requesting the first and second user terminals to re-rate the selected questions.

4. The method of claim 1, further comprising determining ranks of questions based on the ratings of the first and second user terminals.

5. The method of claim 4, wherein the ranks are determined based on final results calculated by applying weights to each of the ratings of the first and second user terminals.

6. The method of claim 4, further comprising providing points assigned to questions to a third user terminal that registered the questions, based on the ranks.

7. The method of claim 1, further comprising receiving a performance result of the selected examination paper from the second user terminal, and providing a grade of the performance result to the second user terminal.

8. The method of claim 1, further comprising receiving questions and question information from a third user terminal.

9. The method of claim 8, wherein the question information comprises at least one of a subject and unit of a question, a difficulty level of a question, question generator information, and learner information.

10. The method of claim 8, further comprising providing grade information of question generators determined based on points assigned to questions and numbers of times the questions are selected according to the ratings to the first through third user terminals.

11. An apparatus for generating learning contents, the apparatus comprising:
a question extracting module for receiving a setting on an examination paper condition from a first user terminal and providing a list of questions matching the examination paper condition to the first user terminal;
an examination paper generating module for receiving a selection of questions from the list of questions from the first user terminal and generating an examination paper based on the selected questions;
an examination paper extracting module for receiving a selection of examination paper from a list of examination papers from a second user terminal and providing a selected examination paper to the second user terminal; and
a question evaluating module for requesting the first and second user terminals to rate the selected questions in the generated examination paper, and receiving ratings from the first and second user terminals.

12. The apparatus of claim 11, wherein the examination paper condition comprises at least one condition chosen from a subject and unit of an examination paper, a difficulty level of questions, or learner information.

13. The apparatus of claim 11, wherein, when a difference between the ratings of the first and second user terminals is equal to or higher than a set range, the question evaluating module requests the first and second user terminals to re-rate the selected questions.

14. The apparatus of claim 11, wherein the question evaluating module determines ranks of questions based on the ratings of the first and second user terminals.

15. The apparatus of claim 14, wherein the question evaluating module provides points assigned to questions to a third user terminal that registered questions, based on the ranks.

16. The apparatus of claim 11, further comprising a learning evaluating module for receiving a performance result of the selected examination paper from the second user terminal, and providing a grade of the performance result to the second user terminal.

17. The apparatus of claim 11, further comprising a question registering module for storing questions and question information received from a third user terminal.

18. The apparatus of claim 17, wherein the question information comprises at least one of a subject and unit of a question, a difficulty level of a question, question generator information, and learner information.

19. The apparatus of claim 17, wherein the question evaluating module provides grade information of question generators determined based on points assigned to questions and numbers of times the questions are selected according to the ratings to the first through third user terminals.

20. A computer-readable recording medium having recorded thereon a program for executing the method of claim 1.
